(19) United States
(12) Patent Application Publication
(10) Pub. No.: US 2017/0266849 A1
(43) Pub. Date: Sep. 21, 2017

(54) ICE CUBE TRAY

(71) Applicant: Assembly Brands, LLC, Brooklyn, NY (US)

(72) Inventors: Eric Prum, Brooklyn, NY (US); Joshua Williams, Brooklyn, NY (US)

(21) Appl. No.: 15/076,370

(22) Filed: Mar. 21, 2016

(51) Int. Cl. B29C 33/40; F25C 1/24

(52) U.S. Cl. CPC B29C 33/405; F25C 1/243; B29K 2083/005

(57) ABSTRACT

Disclosed is an ice cube tray with a free standing cube design. The ice cube tray may include a peripheral frame encircling a plurality of pockets for receiving water to be formed into individual ice cubes when frozen. Each pocket has a generally cubical configuration. Further, the individual pockets maintain a distance between each other, such that the individual pockets do not support each other and are free standing with respect to each other.

### FIELD OF DISCLOSURE

The present disclosure generally relates to ice cube trays. More specifically, the present disclosure relates to an ice cube tray with a free standing cube design.

### BACKGROUND

Ice cube trays are generally placed in a refrigeration compartment of a typical residential refrigerator. Ice cube trays include pockets which are manually filled with water before placing the ice cube tray in the refrigerator. After sometime, the water freezes into ice cubes inside the pockets. The ice cubes can then be removed from the ice tray when required.

In conventional ice cube trays, the individual pockets are connected to other pockets in the tray to provide strength to the ice cube tray. However, it becomes difficult to remove the ice cubes from these trays, as a user cannot easily manipulate the shape of these ice cube trays to squeeze out the ice cubes.

On the other hand, some conventional ice cube trays are very flexible. But they often break when a user tries to manipulate the shape of the ice cube trays to squeeze out the ice cubes.

Accordingly, there is a need for improved ice cube trays that may overcome at least some of the problems with conventional ice cube trays.

### BRIEF OVERVIEW

A freestanding ice cube tray may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure describes an ice cube tray including a peripheral frame encircling a plurality of pockets for receiving water to be formed into individual ice cubes when frozen. Each pocket has a generally cubical configuration. Further, the individual pockets maintain a distance between each other. Therefore, the individual pockets do not support each other and are free standing with respect to each other. This allows for easy removal of the cube from the mold once the ice cubes are formed.

In some embodiments, the peripheral frame may be generally rectangular. Further, the ice cube tray may include multiple parallel rows of pockets. For example, an ice cube tray may have two parallel rows of four pockets each. This ice cube tray may have eight pockets in total. In some embodiments, each pocket may include five walls, including four side walls and one bottom wall. The top face of the pocket may be kept open to receive water while it is being refilled, and to let an ice cube move out of the pocket when the water freezes into the ice cube.

In some embodiments, the frame includes a pair of elongated strips which may be connected integrally to a pair of transversely extending end strips. Further, the pair of elongated strips may also be connected together by a series of inner strips. Yet further, the pair of transversely extending end strips may also be connected together by a longitudinally extending strip, which extends through the center of each of the transversely extending end strips. In some embodiments, the frame may also include a peripheral skirt attached to the pair of elongated strips. In some embodiments, the ice cube tray may be a one-piece tray.

In some embodiments, the ice cube tray may be made using flexible silicone materials that allow for easy filling and removal of ice cubes from the tray. In some embodiments, the ice cube tray may feature a matte finish on the flexible silicone materials, which provide for an easier release of the cubes from the tray once they are frozen. In some embodiments, the ice cube tray may include a reinforcing internal metal frame to provide strength to the ice cube tray.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a top view of an ice cube tray in accordance with various embodiment of the present disclosure;

FIG. 2 is a perspective view of an ice cube tray in accordance with the first embodiment of the present disclosure;

FIG. 3 is a side view of an ice cube tray in accordance with the first embodiment of the present disclosure;

FIG. 4 is another side view of an ice cube tray in accordance with the first embodiment of the present disclosure;

FIG. 5 is a top view of an ice cube tray in accordance with another embodiment of the present disclosure;

FIG. 6 is a perspective view of an ice cube tray in accordance with the first embodiment of the present disclosure;

FIG. 7 is a side view of an ice cube tray in accordance with the first embodiment of the present disclosure;

FIG. 8 is another side view of an ice cube tray in accordance with the first embodiment of the present disclosure; and

FIG. 9 is a perspective view of the ice cube tray having a cut away to illustrate an internally embedded metal frame.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of making ice cubes, embodiments of the present disclosure are not limited to use only in this context.

### I. OVERVIEW

Consistent with embodiments of the present disclosure, an ice cube tray with a free standing cube design may be provided. This overview is provided to introduce a selection of concepts in a simplified form that are further described below. This overview is not intended to identify key features or essential features of the claimed subject matter. Nor is this overview intended to be used to limit the claimed subject matter's scope. The ice tray may be used to freeze water into ice cubes, which may then be easily removed from the ice tray once the ice cubes are formed.

The present disclosure relates generally to ice cube trays, such as for example, the ice cube trays that are placed in a refrigeration compartment of a typical residential refrigerator. More specifically, the present disclosure relates to an improved ice cube tray with a free standing cube design wherein the individual pockets of the ice cube tray do not touch or support each other and are free standing with respect to each other. This allows for easy removal of the cube from the mold once the ice is frozen.

The ice cube tray of the present disclosure may be made using flexible silicone materials such as BPA-free silicone, which is a highly flexible food-safe material that allows for easy filling and removal of ice cubes from the tray. Further, the ice cube trays may feature a matte finish on the silicon materials used, which provide for an easier release of the cubes from the tray once they are frozen. Moreover, ice cube trays may feature an internal metal frame, which is embedded along the edge of the silicone tray. This internal frame provides stability when filling and transferring the tray to the freezer, and helps support the tray when it is stacked on other trays.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. CONFIGURATION

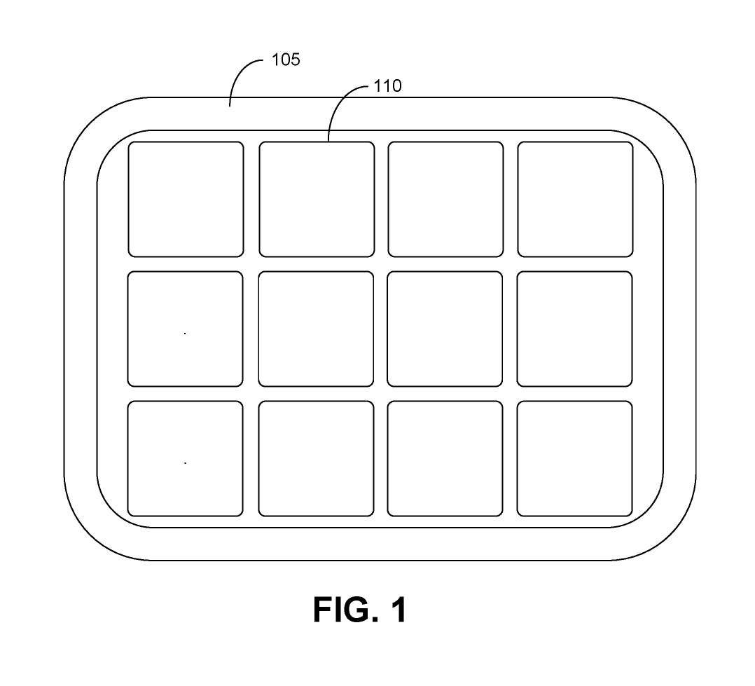

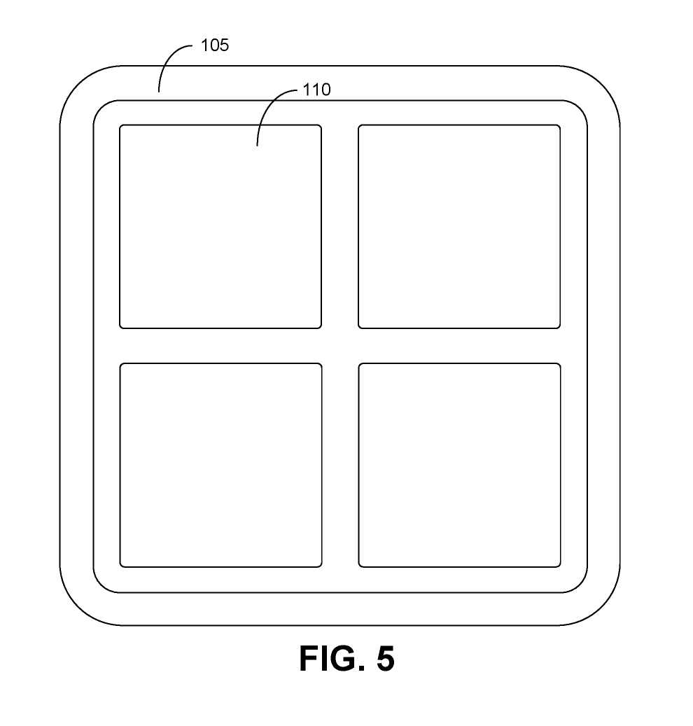

In general, an ice cube tray including a peripheral frame encircling a plurality of pockets for receiving water to be formed into individual ice cubes when frozen. The ice cube tray may include multiple parallel rows of pockets. FIGS. 1 to 4 illustrate various views of an ice cube tray with three parallel rows of four pockets each. FIGS. 5 to 8 illustrate various views of an ice cube tray with two parallel rows of two pockets each.

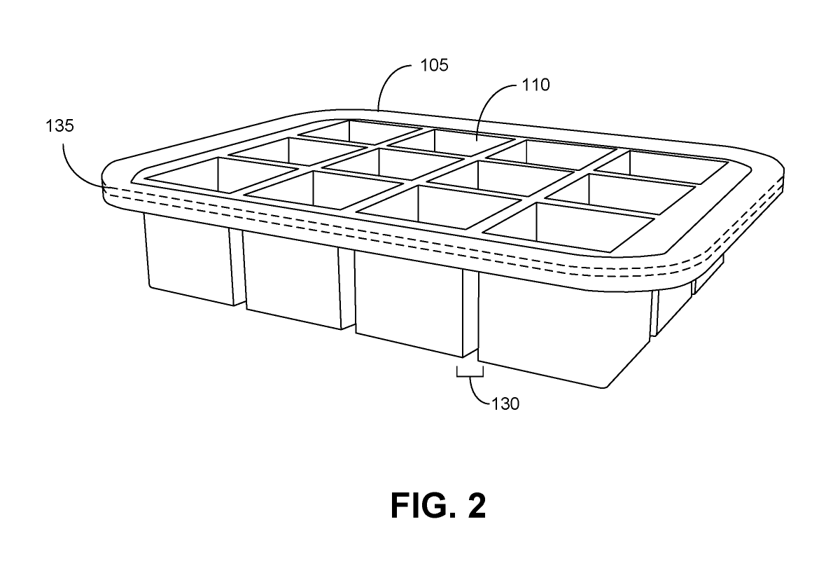

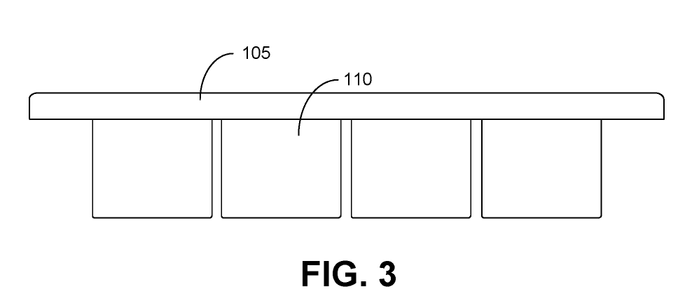

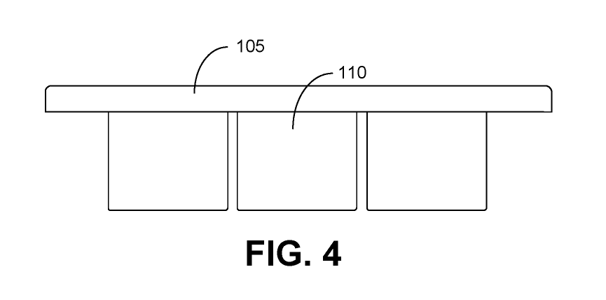

FIG. 1 is a top view of an ice cube tray in accordance with an embodiment of the present disclosure. FIG. 2 is a perspective view of an ice cube tray; FIG. 3 is a side view of an ice cube tray and FIG. 4 is another side view of an ice cube tray.

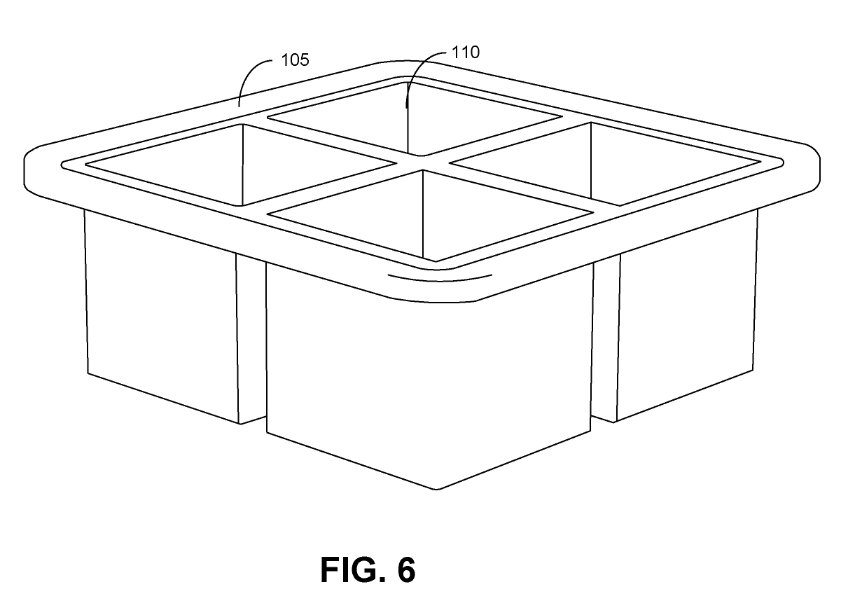

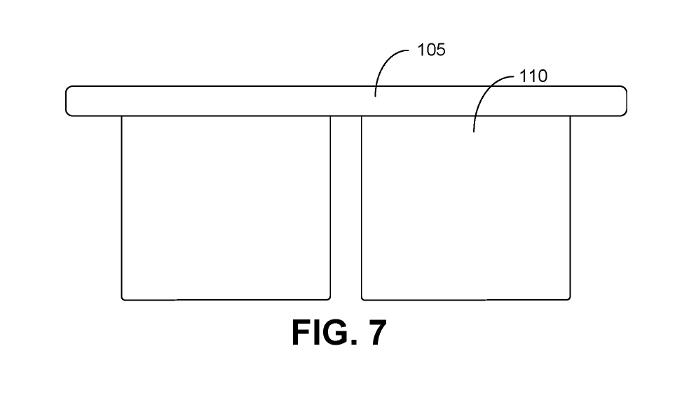

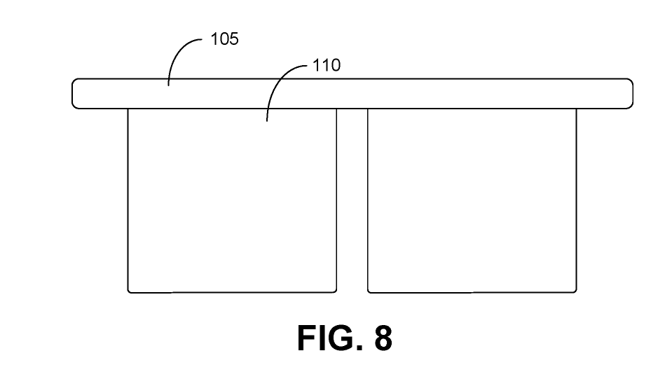

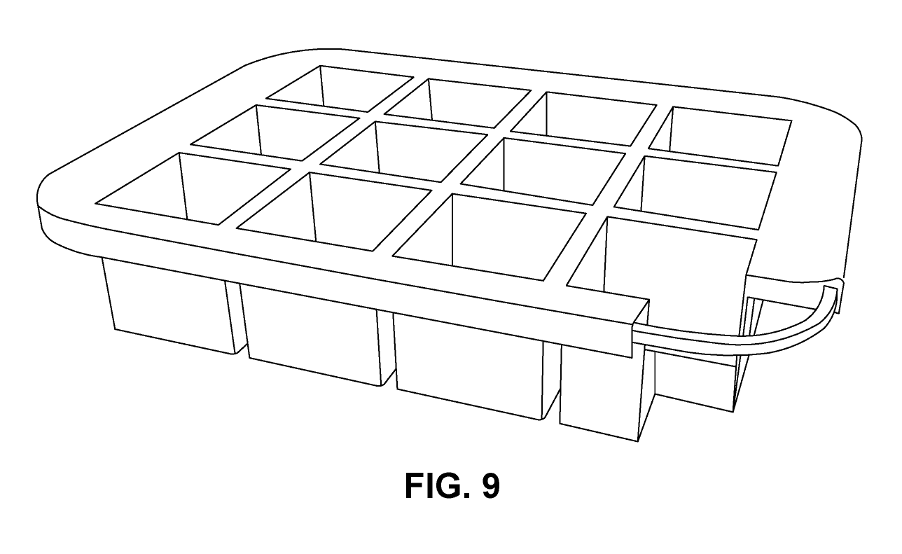

FIG. 5 is a top view of an ice cube tray in accordance with another embodiment of the present disclosure. FIG. 6 is a perspective view of an ice cube tray; FIG. 7 is a side view of an ice cube tray and FIG. 8 is another side view of an ice cube tray. FIG. 9 is a perspective view of the ice cube tray having a cut away to illustrate an internally embedded metal frame.

The ice cube tray includes a peripheral frame 105 encircling a plurality of pockets 110 for receiving water to be formed into individual ice cubes when frozen. The peripheral frame 105 may be generally rectangular. Further, the frame 105 may include a pair of elongated strips which may be connected integrally to a pair of transversely extending end strips. The pair of elongated strips may also be connected together by a series of inner strips. Further, the pair of transversely extending end strips may also be connected together by a longitudinally extending strip, which extends through the center of each of the transversely extending end strips. Moreover, the frame includes a peripheral skirt attached to the pair of elongated strips.

Further, in some embodiments, the ice cube tray may include two parallel rows of pockets 110. Each pocket has a generally cubical configuration comprising five walls, including four side walls and one bottom wall. The individual pockets 110 maintain a distance 130 between each other. This allows for easy removal of the cube from the mold once the ice is frozen.

Further, in some embodiments, the ice cube tray may be made using flexible silicone materials. For example, BPA-free silicone, which is a highly flexible food-safe material that allows for easy filling and removal of ice cubes from the tray. Further, the flexible silicone materials may feature a matte finish, which provide for an easier release of the cubes from the tray once they are frozen.

Furthermore, in some embodiments, the ice cube tray may also include a reinforcing internal metal frame 135. The metal frame may be embedded along the edge of the silicone tray. The internal frame provides stability when filling and transferring the tray to the freezer, and helps support the tray when it is stacked on other trays. The entire ice cube tray may be made of one-piece.

### III. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. An ice cube tray comprising:
a peripheral frame encircling a piece tray comprising a plurality of pockets for receiving a liquid to be formed into individual solidified formations when frozen, wherein each pocket of the plurality of pockets has flexible walls, wherein the pockets maintain a distance between each other to allow for a flexing of the flexible walls, and
wherein the peripheral frame comprises a reinforcing internal metal frame completely embedded within the peripheral frame positioned along the edge of the one piece tray.

2. The ice cube tray of claim 1, wherein the ice cube tray is made using flexible silicone materials.

3. The ice cube tray of claim 2, wherein the ice cube tray features a matte finish on the flexible silicone materials.

4. (canceled)

5. The ice cube tray of claim 1, wherein the peripheral frame is generally rectangular, wherein the ice cube tray includes two parallel rows of pockets.

6. The ice cube tray of claim 5, wherein the one piece tray comprises a pair of elongated strips which are connected integrally to a pair of transversely extending end strips.

7. The ice cube tray of claim 6, wherein the pair of elongated strips is also connected together by a series of inner strips.

8. The ice cube tray of claim 6, wherein the pair of transversely extending end strips is also connected together by a longitudinally extending strip, which extends through the center of each of the transversely extending end strips.

9. The ice cube tray of claim 6, wherein the one piece tray includes a peripheral skirt attached to the pair of elongated strips.

10. The ice cube tray of claim 1, wherein each pocket comprises five walls, including four side walls and one bottom wall.

11. (canceled)

12. The ice cube tray of claim 1, wherein the peripheral frame comprising the embedded metal frame provides stability when filling the one piece tray with water and transferring the one piece tray.

13. The ice cube tray of claim 1, wherein the peripheral frame comprising the embedded metal frame enables stacking of the one piece tray onto additional one piece trays.
